(19) United States
(12) Patent Application Publication
(10) Pub. No.: US 2026/0158915 A1
(43) Pub. Date: Jun. 11, 2026

(54) DISPLAY CONTROL DEVICE

(71) Applicant: TOYOTA JIDOSHA KABUSHIKI KAISHA, Toyota-shi (JP)

(72) Inventors: Sae ONISHI, Nagoya-shi (JP); Hitoshi KUMON, Aichi-gun (JP)

(73) Assignee: TOYOTA JIDOSHA KABUSHIKI KAISHA, Toyota-shi (JP)

(21) Appl. No.: 19/289,777

(22) Filed: Aug. 4, 2025

(30) Foreign Application Priority Data
Dec. 6, 2024 (JP) 2024-213864

(51) Int. Cl. B60K 35/81; B60K 35/29

(52) U.S. Cl. CPC B60K 35/81; B60K 35/29; B60K 2360/167; B60K 2360/172; B60K 2360/1876

(57) ABSTRACT

A display control device includes a controller configured to display a meter image indicating an engine rotation speed of a vehicle, vehicle-speed information indicating a vehicle speed of the vehicle, and gear stage information in a fractional format in which a value of a current gear stage of the vehicle is a numerator and a value of a gear stage indicating an upper limit set by a driver of the vehicle is a denominator, on a display unit provided in front of a driver's seat of the vehicle.

### CROSS-REFERENCE TO RELATED APPLICATION

This application claims priority to Japanese Patent Application No. 2024-213864 filed on Dec. 6, 2024. The disclosure of the above-identified application, including the specification, drawings, and claims, is incorporated by reference herein in its entirety.

### BACKGROUND

### 1. Technical Field

The present disclosure relates to a display control device.

### 2. Description of Related Art

Japanese Unexamined Patent Application Publication No. 2022-030862 (JP 2022-030862 A) discloses a technique in which a display unit is provided in a tachometer, and a current shift mode simulating a gear stage of an MT vehicle is displayed on the display unit.

### SUMMARY

Some drivers want to confirm a current gear stage that can correspond to the current shift mode described in JP 2022-030862 A and an upper limit value of the gear stage while the vehicle is traveling. In a case where the two types of gear stages are displayed on the display unit provided in front of a driver's seat of the vehicle, displaying the two types of gear stages solely by numerical values is desirable due to a constraint of a display area. Therefore, in a case where the two types of gear stages are displayed on the display unit, devising a display method of each numerical value is needed in order to prevent the driver from being confused.

Therefore, an object of the present disclosure is to provide a display control device capable of allowing a driver to grasp which gear stage each numerical value indicates from a display format of a current gear stage and an upper limit value of a gear stage on a display unit.

A display control device according to a first aspect of the present disclosure includes
a controller configured to display, on a display unit provided in front of a driver's seat of a vehicle, a meter image indicating an engine rotation speed of the vehicle, vehicle-speed information indicating a vehicle speed of the vehicle, and gear stage information in a fractional format in which a value of a current gear stage of the vehicle is a numerator and a value of a gear stage that indicates an upper limit set by a driver of the vehicle is a denominator.

In the display control device according to the first aspect of the present disclosure, the controller displays, on the display unit, the meter image, the vehicle-speed information indicating the vehicle speed, and the gear stage information in the fractional format in which the value of the current gear stage is the numerator and the value of the gear stage that indicates the upper limit set by the driver is the denominator. In the display control device, the upper limit value of the gear stage at which a value larger than the current gear stage can be set is displayed as the denominator and the current gear stage is displayed as the numerator, whereby the driver can grasp a degree of the current gear stage with respect to the upper limit value of the gear stage from the gear stage information. Therefore, with the display control device, the driver can grasp which gear stage each numerical value indicates from the display format of the current gear stage and the upper limit value of the gear stage on the display unit.

In the display control device according to a second aspect of the present disclosure, the controller in the first aspect of the present disclosure is configured to display, to be adjacent to the meter image, a gauge image in which a plurality of gauges corresponding to the value of the denominator of the gear stage information is arranged along a predetermined direction, the controller being configured to illuminate, among the gauges, the number of gauges corresponding to the value of the numerator of the gear stage information.

In the display control device according to the second aspect of the present disclosure, the controller displays, to be adjacent to the meter image, the gauge image in which the gauges corresponding to the value of the denominator of the gear stage information are arranged along the predetermined direction. The controller illuminates, among the gauges, the number of gauges corresponding to the value of the numerator of the gear stage information. As a result, with the display control device, the driver can easily grasp a meaning of a numerical value indicated in the gear stage information by a correspondence between the number of gauges and the number of illuminated gauges and the gear stage information being indicated.

In the display control device according to a third aspect of the present disclosure, the controller in the first or second aspect of the present disclosure is configured to display the gear stage information in a central part of an arc of the meter image having an arc shape, the controller being configured to display warning information indicating a content of a warning in the central part of the arc of the meter image and shift and display the gear stage information at a position within the arc of the meter image that does not overlap the warning information when a warning condition based on a state of the vehicle is met.

In the display control device according to the third aspect of the present disclosure, the controller displays the warning information indicating the content of the warning in the central part of the arc of the meter image and shifts and displays the gear stage information at the position within the arc of the meter image that does not to overlap the warning information when the warning condition is met. As a result, with the display control device, even in a case where an amount of information to be displayed within the arc of the meter image in which a display area is limited is increased due to the meeting of the warning condition, the current gear stage and the upper limit value of the gear stage can be continuously displayed together with the content of the warning.

In the display control device according to a fourth aspect of the present disclosure, the controller in any one of the first to third aspects of the present disclosure is configured to display solely the value of the current gear stage as the gear stage information when a shift position of the vehicle is in an M range in which the gear stage is changeable by an operation of the driver.

In the display control device according to the fourth aspect of the present disclosure, the controller displays solely the value of the current gear stage as the gear stage information when the shift position is in the M range. As a result, with the display control device, when the shift position is in the M range, the driver can be relieved from a feeling of being bothered by a display content of the gear stage information as compared with a configuration for displaying the current gear stage and the upper limit value of the gear stage.

In the display control device according to a fifth aspect of the present disclosure, the controller in any one of the first to fourth aspects of the present disclosure is configured to display the gear stage information when a current location of the vehicle is within a travel area that is predetermined.

In the display control device according to the fifth aspect of the present disclosure, the controller displays the gear stage information when the current location of the vehicle is within the travel area that is predetermined. As a result, with the display control device, the driver can grasp the current gear stage and the upper limit value of the gear stage solely when the vehicle is traveling in the travel area that is predetermined.

As described above, in the display control device according to the present disclosure, it is possible to make the driver to grasp which gear stage each numerical value indicates from the display format of the current gear stage and the upper limit value of the gear stage on the display unit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a hardware configuration of a vehicle;

FIG. 2 is a flowchart showing a flow of the specific processing;

FIG. 3 is a first display example displayed on the monitor;

FIG. 4 is a second display example displayed on the monitor;

FIG. 5 is a third display example displayed on the monitor; and

FIG. 6 is a fourth display example displayed on the monitor.

### DETAILED DESCRIPTION OF EMBODIMENTS

### First Embodiment

Hereinafter, the vehicle 10 according to the present embodiment will be described. First, a first embodiment of the vehicle 10 according to the present embodiment will be described.

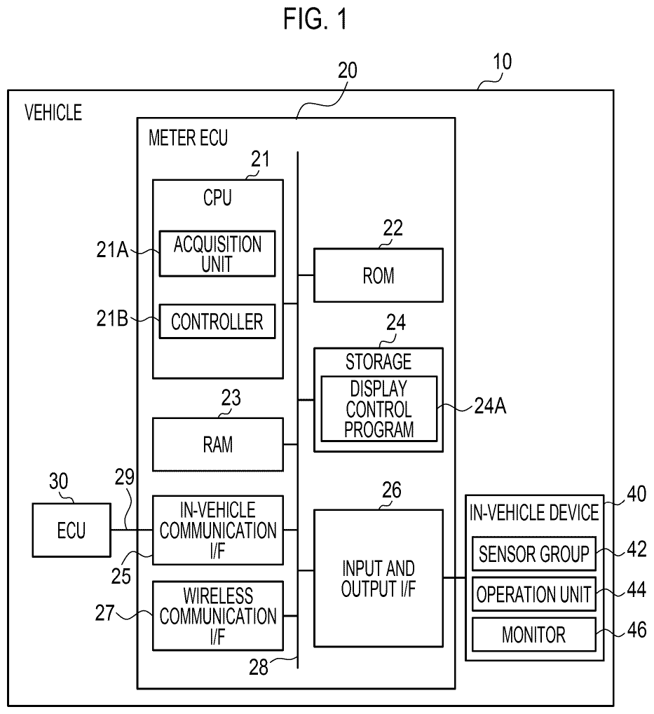

FIG. 1 is a block diagram showing a hardware configuration of a vehicle 10. As shown in FIG. 1, the vehicle 10 includes a meter electronic control unit (ECU) 20. The vehicle 10 is an example of a “vehicle” of the present disclosure, and the meter ECU 20 is an example of a “display control device” of the present disclosure.

The meter ECU 20 includes a central processing unit (CPU) 21, a read only memory (ROM) 22, and a random access memory (RAM) 23. In addition, the meter ECU 20 is configured to include a storage 24, an in-vehicle communication interface (I/F) 25, an input and output I/F 26, and a wireless communication I/F 27. The CPU 21, the ROM 22, the RAM 23, the storage 24, the in-vehicle communication I/F 25, the input and output I/F 26, and the wireless communication I/F 27 are connected to each other to be able to communicate with each other via an internal bus 28.

The CPU 21 is a central processing unit that executes various programs or controls each unit. That is, the CPU 21 reads a program from the ROM 22 or the storage 24 and executes the program using the RAM 23 as a work area. The CPU 21 controls each configuration and executes various types of arithmetic processing in accordance with a program recorded in the ROM 22 or the storage 24.

The ROM 22 stores various programs and various data. The RAM 23 temporarily stores a program or data as a work area.

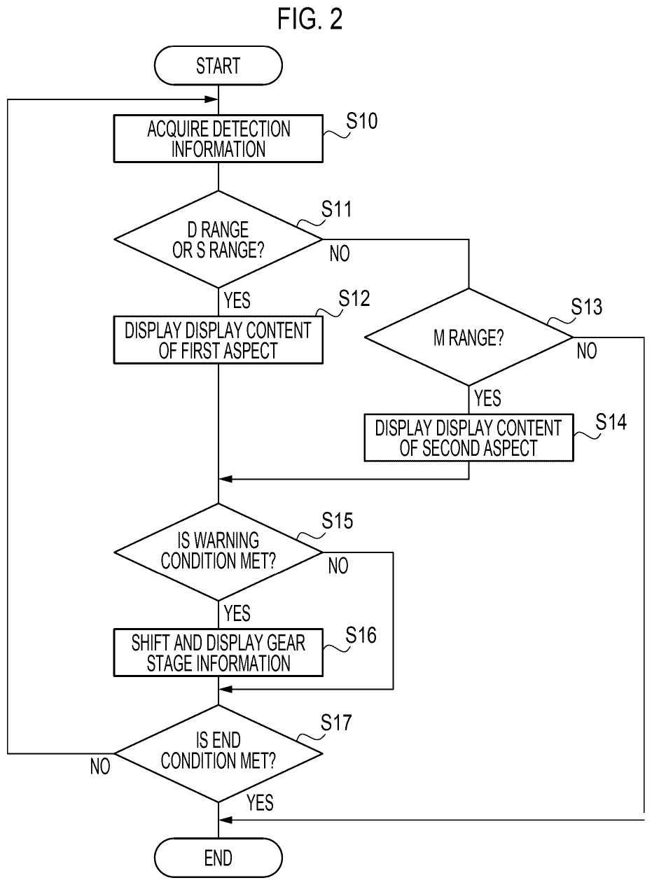

The storage 24 is configured by a storage device, such as an embedded multimedia card (eMMC) or universal flash storage (UFS), and stores various programs and various data. The storage 24 stores a display control program 24A. The display control program 24A is a program for causing the CPU 21 to execute specific processing (see FIG. 2) described later.

The in-vehicle communication I/F 25 is an interface for connecting to the other ECU 30. The interface uses a communication standard by a CAN protocol. The in-vehicle communication I/F 25 is connected to the external bus 29. Although not shown, a plurality of ECUs is provided for each function of the vehicle 10 in addition to the ECU 30.

The input and output I/F 26 is an interface for communicating with the in-vehicle device 40 mounted on the vehicle 10.

The in-vehicle device 40 is various devices mounted on the vehicle 10. The vehicle 10 includes a sensor group 42, an operation unit 44, and a monitor 46 as examples of the in-vehicle device 40.

The sensor group 42 includes, for example, a 3D-LiDAR sensor, a millimeter wave sensor, an infrared sensor, a turn-signal sensor, an accelerator position sensor, a shift sensor, a vehicle speed sensor, a steering-angle sensor, and an angular velocity sensor. In addition, the sensor group 42 includes sensors detecting a state of the vehicle 10 and a surrounding situation of the vehicle 10, such as a global positioning system (GPS) sensor, an ambient-light sensor, a gyro sensor, a steering-angle sensor, and an acceleration sensor, a plurality of cameras imaging surroundings of the vehicle 10, and the like. The sensor group 42 outputs the detection results of the respective sensors and the captured images by the respective cameras to the meter ECU 20, the ECU 30, and the like.

The operation unit 44 is various switches, levers, and the like that receive an operation by the driver of the vehicle 10. The operation unit 44 is configured to include, for example, an ignition switch, a shift lever, and a paddle shift. The operation unit 44 outputs the operation contents of various switches, levers, and the like to the meter ECU 20, the ECU 30, and the like.

The monitor 46 is provided in a meter panel disposed in front of a driver's seat of the vehicle 10, and is a meter display for displaying an image or the like relating to a proposal of an operation relating to a function of the vehicle 10 and a description of the function. The monitor 46 is an example of a “display unit” in the present disclosure.

The wireless communication I/F 27 is a wireless communication module for communicating with an external device. The wireless communication module uses, for example, a communication standard, such as 5G, LTE, Wi-Fi (registered trademark), and Bluetooth (registered trademark).

In addition, the CPU 21 of the meter ECU 20 includes an acquisition unit 21A and a controller 21B as a functional configuration. Each functional configuration is realized by the CPU 21 reading out and executing the display control program 24A stored in the storage 24. The controller 21B is an example of a “controller” in the present disclosure.

The acquisition unit 21A acquires various kinds of information. For example, the acquisition unit 21A acquires detection information that can be detected by the vehicle 10 as various pieces of information. The detection information includes a detection result by each sensor configuring the sensor group 42 and a captured image or the like by each camera. In addition, the acquisition unit 21A acquires, as various pieces of information, an upper limit value of a gear stage that is a value of the gear stage indicating an upper limit set by the driver. The driver operates the shift lever included in the operation unit 44 to switch the shift position to a D range (drive position) or an S range (second position). Thereafter, the driver can operate the paddle shift included in the operation unit 44 to set the upper limit value of the gear stage. For example, the driver sets an upper limit value of the gear stage in order to prevent the gear from being shifted up too much on a downhill. In this case, on the downhill, the gear is not upshifted to a value (for example, 3) set as an upper limit value.

The shift position is configured to be switched to a P range (parking position) and an R range (reverse position) in addition to the D range and the S range. In addition, the shift position is configured to be switched to an N range (neutral position) and an M range (manual position).

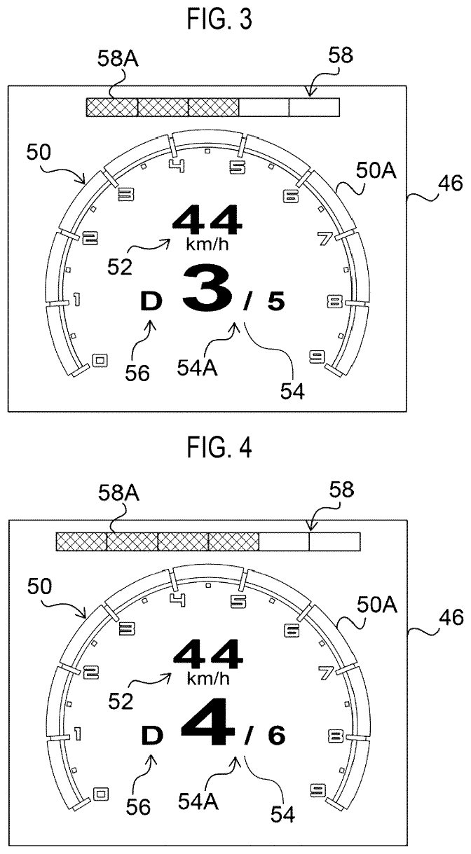

The controller 21B executes display control related to the display of the monitor 46. For example, as shown in FIG. 3, the controller 21B causes the monitor 46 to display a meter image 50 having an arc shape that indicates the engine rotation speed of the vehicle 10. In addition, the controller 21B displays vehicle-speed information 52 indicating the vehicle speed of the vehicle 10 and gear stage information 54 in a fractional format in which the value of the current gear stage of the vehicle 10 is a numerator and the upper limit value of the gear stage is a denominator, within the arc of the meter image 50.

FIG. 2 is a flowchart showing a flow of specific processing executed by the meter ECU 20. The CPU 21 reads the display control program 24A from the storage 24, expands the program in the RAM 23, and executes the program, whereby the specific processing is executed. As an example, the specific processing is repeatedly and automatically executed each time a certain time elapses.

In S10 shown in FIG. 2, the CPU 21 acquires detection information that can be detected by the vehicle 10. Then, the CPU 21 proceeds to S11.

In S11, the CPU 21 determines whether the shift position of the vehicle 10 is in the D range or the S range based on the detection information acquired in S10. Here, when determination is made that the shift position is in the D range or the S range (S11: YES), the CPU 21 proceeds to S12. On the other hand, when the determination is made that the shift position is not in the D range or the S range (S11: NO), the CPU 21 proceeds to S13.

In S12, the CPU 21 acquires the upper limit value of the gear stage, and causes the monitor 46 to display the display content of the first aspect in which the gear stage information 54 in the fractional format is displayed within the arc of the meter image 50. Specific examples of the display content of the first aspect will be described below. Then, the CPU 21 proceeds to S15.

In S13, the CPU 21 determines whether the shift position of the vehicle 10 is in the M range based on the detection information acquired in S10. Here, when determination is made that the shift position is in the M range (S13: YES), the CPU 21 proceeds to S14. On the other hand, when the determination is made that the shift position is not in the M range (S13: NO), the CPU 21 ends the specific processing.

In S14, the CPU 21 causes the monitor 46 to display the display content of the second aspect in which the upper limit value of the gear stage is not indicated and solely the value of the current gear stage is indicated as the gear stage information 54. Specific examples of the display content of the second aspect will be described below. Then, the CPU 21 proceeds to S15.

In S15, the CPU 21 determines whether the warning condition based on the state of the vehicle 10 is met based on the detection information acquired in S10. Here, when the determination is made that the warning condition is met (S15: YES), the CPU 21 proceeds to S16. On the other hand, when the determination is made that the warning condition is not met (S15: NO), the CPU 21 proceeds to S17. The warning condition can be appropriately set, such as a condition based on the vehicle speed of the vehicle 10 and a condition based on the traveling route of the vehicle 10. As an example, the CPU 21 determines that the warning condition is met in a case where the vehicle 10 travels at a vehicle speed exceeding an upper limit set as the warning condition.

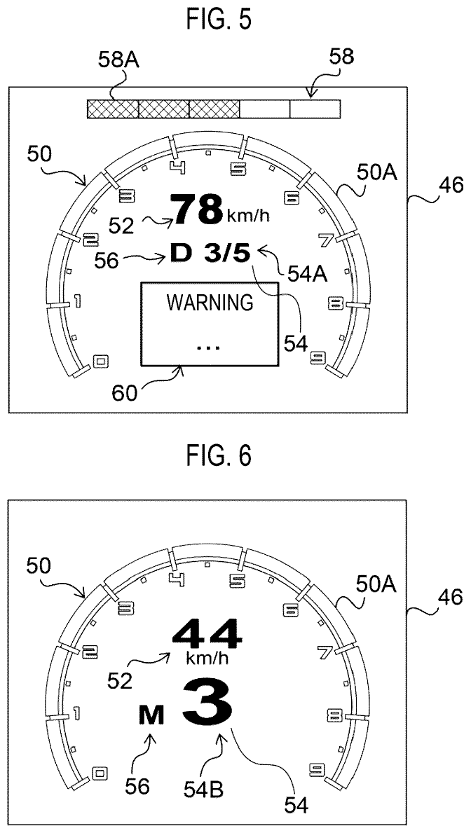

In S16, the CPU 21 displays the warning information 60 (see FIG. 5) indicating the content of the warning according to the warning condition met in S15 on the central part of the arc of the meter image 50. Then, the CPU 21 shifts the gear stage information 54 to a position where the gear stage information 54 does not overlap the warning information 60 within the arc of the meter image 50 and displays the gear stage information 54. Then, the CPU 21 proceeds to S17.

In S17, the CPU 21 determines whether a predetermined end condition is met. Here, when the determination is made that the end condition is met (S17: YES), the CPU 21 ends the specific processing. On the other hand, when the determination is made that the end condition is not met (S17: NO), the CPU 21 returns to S10. As an example, the CPU 21 determines that the end condition is met in a case where the ignition switch is turned off.

Next, a display example of the monitor 46 will be described with reference to FIGS. 3 to 6.

FIG. 3 is a first descriptive view showing a display example displayed in a predetermined display area of the monitor 46. The predetermined display area is a part of the monitor 46, and is visible to the driver seated in the driver's seat through the opening of the steering wheel.

The monitor 46 shown in FIG. 3 displays a meter image 50, vehicle-speed information 52, gear stage information 54, shift information 56, and a gauge image 58.

The meter image 50 is an image of a tachometer indicating an engine rotation speed of the vehicle 10. The meter image 50 includes nine gauges 50A having an arc shape. In addition, the meter image 50 has an arc shape as a whole by disposing the nine gauges 50A integrally to provide one arc. Although not shown, the meter image 50 is configured such that a number of gauges 50A corresponding to the engine rotation speed are illuminated.

The vehicle-speed information 52, the gear stage information 54, and the shift information 56 are disposed within an arc of the meter image 50.

The gear stage information 54 shown in FIG. 3 shows the gear stage information 54A of the first aspect in a case where the shift position of the vehicle 10 is in the D range or the S range. The gear stage information 54A is displayed in a central part of the arc of the meter image 50. The gear stage information 54A in the fractional format displays “3” as a numerator that is the value of current gear stage, and “5” as a denominator that is the upper limit value of the gear stage. As a result, the gear stage information 54A indicates that the current gear stage is “3” and the upper limit value of the gear stage is “5”.

The vehicle-speed information 52 indicates the vehicle speed of the vehicle 10. The vehicle-speed information 52 is displayed to be adjacent to above the gear stage information 54A in the arc of the meter image 50. In FIG. 3, the vehicle-speed information 52 is displayed as “44 km/h”, and indicates that the vehicle speed is 44 km/h.

The shift information 56 indicates a shift position of the vehicle 10. The shift information 56 is displayed to be adjacent to the left of the gear stage information 54A within the arc of the meter image 50. In FIG. 3, the shift information 56 is displayed as “D”, and indicates that the shift position is in the D range.

The gauge image 58 is an image in which a plurality of gauges 58A corresponding to the value of the denominator of the gear stage information 54A is arranged along the left-right direction on the monitor 46. The gauge image 58 is displayed to be adjacent to above the meter image 50 on the monitor 46. In addition, the gauge image 58 illuminates the number of the gauges 58A according to the value of the numerator of the gear stage information 54A among the plurality of gauges 58A. Therefore, the gauge image 58 shown in FIG. 3 displays five gauges 58A according to the value of the denominator of the gear stage information 54A, and illuminates three gauges 58A according to the value of the numerator of the gear stage information 54A. The left-right direction is an example of the “predetermined direction” of the present disclosure.

FIG. 4 is a second descriptive view showing a display example displayed in a predetermined display area of the monitor 46. As an example, FIG. 4 shows a state in which the display content is changed from the display example of FIG. 3.

On the monitor 46 shown in FIG. 4, the meter image 50, the vehicle-speed information 52, the gear stage information 54, the shift information 56, and the gauge image 58 are displayed as in FIG. 3.

Here, the state shown in FIG. 4 is a state after the CPU 21 has received the operation by the driver on the paddle shift included in the operation unit 44. Therefore, the gear stage information 54A shown in FIG. 4 indicates that the value of the denominator is increased to “6” and the upper limit value of the gear stage is “6”. In addition, the state shown in FIG. 4 is a state after the vehicle 10 has changed the gear from the state shown in FIG. 3. Therefore, the gear stage information 54A indicates that the value of the numerator has been increased to “4”, and the current gear stage is “4”.

In addition, the gauge image 58 shown in FIG. 4 changes the display content from FIG. 3 according to the content of the gear stage information 54A. Specifically, the gauge image 58 displays six gauges 58A according to the value of the denominator of the gear stage information 54A and illuminates four gauges 58A according to the value of the numerator of the gear stage information 54A.

FIG. 5 is a third descriptive view showing a display example displayed in a predetermined display area of the monitor 46. As an example, FIG. 5 shows a state after the warning condition is met.

The monitor 46 shown in FIG. 5 displays a meter image 50, vehicle-speed information 52, gear stage information 54, shift information 56, a gauge image 58, and warning information 60.

The vehicle-speed information 52, the gear stage information 54, the shift information 56, and the warning information 60 are disposed within the arc of the meter image 50.

The warning information 60 indicates the content of the warning according to the met warning condition. The warning information 60 is displayed in a central part of the arc of the meter image 50. In FIG. 5, “warning . . . ” is displayed as the warning information 60, and indicates that the vehicle 10 is traveling at a vehicle speed exceeding a set upper limit, for example.

In FIG. 5, the display positions of the vehicle-speed information 52, the gear stage information 54, and the shift information 56 are changed in association with the display of the warning information 60 within the arc of the meter image 50. Specifically, the vehicle-speed information 52, the gear stage information 54, and the shift information 56 shown in FIG. 5 are displayed shifted from the positions shown in FIG. 3 or 4 to the upper side of the arc of the meter image 50.

FIG. 6 is a fourth descriptive view showing a display example displayed in a predetermined display area of the monitor 46. As an example, FIG. 6 shows a state in which the shift position of the vehicle 10 is in the M range.

The monitor 46 shown in FIG. 6 displays a meter image 50, vehicle-speed information 52, gear stage information 54, and shift information 56.

The gear stage information 54 shown in FIG. 6 shows the gear stage information 54B of the second aspect in a case where the shift position of the vehicle 10 is in the M range. The gear stage information 54B is displayed in a central part of the arc of the meter image 50. Then, the gear stage information 54B in which solely the value of the current gear stage is indicated is displayed as “3”, indicating that the current gear stage is “3”.

In FIG. 6, “M” is displayed as the shift information 56, and indicates that the shift position is in the M range.

As described above, in the meter ECU 20, the CPU 21 causes the monitor 46 to display the meter image 50 having an arc shape. Then, the CPU 21 displays the vehicle-speed information 52 and the gear stage information 54 in a fractional format in which the value of the current gear stage is the numerator and the upper limit value of the gear stage is the denominator within the arc of the meter image 50. In the meter ECU 20, the driver can grasp the degree of the current gear stage with respect to the upper limit value of the gear stage from the gear stage information 54 by displaying the upper limit value of the gear stage that can be set to a value larger than the current gear stage as a denominator and the current gear stage as a numerator. Therefore, with the meter ECU 20, the driver can grasp which gear stage each numerical value indicates from the display format of the current gear stage and the upper limit value of the gear stage on the monitor 46.

In addition, in the meter ECU 20, the CPU 21 displays the gauge image 58 in which a plurality of gauges 58A according to the value of the denominator of the gear stage information 54 is arranged along the left-right direction, to be adjacent to the meter image 50. Then, the CPU 21 illuminates the number of the gauges 58A according to the value of the numerator of the gear stage information 54 among the plurality of gauges 58A. As a result, the meter ECU 20 shows the correspondence between the number of gauges 58A and the number of illuminated gauges 58A and the gear stage information 54, such that the driver can easily grasp the meaning of the numerical value shown in the gear stage information 54.

In addition, in the meter ECU 20, when the warning condition is met, the CPU 21 displays the warning information 60 indicating the content of the warning on the central part of the arc of the meter image 50. In addition, in the meter ECU 20, when the warning condition is met, the CPU 21 shifts the gear stage information 54 to a position where the gear stage information 54 does not overlap the warning information 60 within the arc of the meter image 50 and displays the gear stage information 54. As a result, with the meter ECU 20, even in a case where the amount of information to be displayed within the arc of the meter image 50 in which the display area is limited is increased due to the meeting of the warning condition, the current gear stage and the upper limit value of the gear stage can be continuously displayed together with the contents of the warning.

In addition, in the meter ECU 20, when the shift position is in the M range, the CPU 21 does not display the upper limit value of the gear stage as the gear stage information 54, and displays solely the value of the current gear stage. In a case of the M range, the current gear stage becomes the upper limit of gear stage, that is, the upper limit gear (requested gear), and thus the display contents are overlapped in a case where both gear stages are displayed. Therefore, the meter ECU 20 displays solely the value of the current gear stage when the shift position is in the M range. As a result, the driver can be relieved from the feeling of being bothered by the display content of the gear stage information 54 as compared with the configuration in which the current gear stage and the upper limit value of the gear stage are displayed.

### Second Embodiment

Next, a second embodiment of the vehicle 10 according to the present embodiment will be described with the overlapping portion with the above-described embodiment omitted or simplified.

In the meter ECU 20 according to the second embodiment, the CPU 21 displays the gear stage information 54 within the arc of the meter image 50 in a case where the current location of the vehicle 10 is within the predetermined travel area. As an example, the CPU 21 determines that the permission condition is met in a case where the current location of the vehicle 10 measured by the GPS sensor included in the sensor group 42 is within the predetermined travel area. The predetermined travel area is, for example, a slope including a downhill and a highway.

With the above configuration, with the meter ECU 20 according to the second embodiment, the driver can grasp the current gear stage and the upper limit value of the gear stage solely when the vehicle 10 travels in the predetermined travel area.

### Others

Hereinbefore, although the embodiments of the present disclosure have been described in detail with reference to the accompanying drawings, the technical scope of the present disclosure is not limited to the examples. Those having ordinary knowledge in the technical field of the present disclosure will appreciate that various modifications or corrections can be made within the scope of the technical thought described in the claims. It is understood that the modifications or the corrections also belong to the technical scope of the present disclosure.

In addition, the effects described in the above embodiment are illustrative or exemplary, and are not limited to those described in the above embodiment. That is, the technique according to the present disclosure can achieve other effects that are apparent to those having ordinary knowledge in the technical field of the present disclosure from the description in the above embodiment, in addition to the effects described in the above embodiment. Alternatively, other effects that are apparent to those having ordinary knowledge in the technical field of the present disclosure can be obtained from the above description in the embodiment, instead of the effects described in the embodiment.

The processing described in the above embodiment can also be realized by a dedicated hardware circuit. In this case, the processing may be executed by one hardware or may be executed by a plurality of pieces of hardware.

In the above-described embodiment, the display control program 24A is stored in the storage 24. However, the present disclosure is not limited thereto, and the display control program 24A may be stored in the ROM 22.

In the above-described embodiment, the monitor 46 that is a meter display is taken as an example of the “display unit” of the present disclosure, but the example of the “display unit” is not limited to the meter display. For example, another example of the “display unit” may be another display, such as a center display and a head-up display (HUD). Further, an example of the “display unit” may be a combination of a plurality of displays, such as a meter display and a center display.

In the above-described embodiment, the gear stage information 54 is displayed as “3/5”, with the numerator and denominator to be adjacent to each other in the left-right direction on the monitor 46, but the present disclosure is not limited thereto. The gear stage information 54 may be displayed with the numerator and denominator to be adjacent to each other in the vertical direction on the monitor 46.

In the above-described embodiment, the gauge image 58 includes the plurality of gauges 58A arranged along the left-right direction on the monitor 46, but the present disclosure is not limited thereto, and the plurality of gauges 58A may be arranged along the vertical direction on the monitor 46.

In the above-described embodiment, the meter ECU 20 is configured to execute the specific processing shown in FIG. 2. However, the present disclosure is not limited thereto, and the specific processing may be executed in cooperation between the meter ECU 20 and another ECU.

Various processors other than the CPU may execute the specific processing executed by the CPU 21 reading software (program) in the above-described embodiment. Examples of the processor in this case include a programmable logic device (PLD) that can change a circuit configuration after manufacturing, such as a field-programmable gate array (FPGA), and a dedicated electric circuit such as an application specific integrated circuit (ASIC). The dedicated electric circuits are processors having a circuit configuration specially designed to execute a specific processing. In addition, the specific processing may be executed by one of the various processors, or may be executed by a combination of two or more processors of the same type or different types (for example, a plurality of FPGAs, and a combination of a CPU and an FPGA). In addition, the hardware structures of the various processors are more specifically an electrical circuit in which circuit elements, such as semiconductor elements, are combined.

In addition, in the above-described embodiment, the aspect in which the display control program 24A is stored (installed) in the storage 24 in advance has been described, but the present disclosure is not limited thereto. The display control program 24A may be provided in a form recorded on a recording medium, such as a compact disk read only memory (CD-ROM) or a digital versatile disk read only memory (DVD-ROM). In addition, the display control program 24A may be provided in a form recorded on a recording medium, such as a universal serial bus (USB) memory. In addition, the display control program 24A may be downloaded from an external device via a network. The technique of the present disclosure can also be applied to a program and a program product.

What is claimed is:

1. A display control device comprising a controller configured to display, on a display unit provided in front of a driver's seat of a vehicle, a meter image indicating an engine rotation speed of the vehicle, vehicle-speed information indicating a vehicle speed of the vehicle, and gear stage information in a fractional format in which a value of a current gear stage of the vehicle is a numerator and a value of a gear stage that indicates an upper limit set by a driver of the vehicle is a denominator.

2. The display control device according to claim 1, wherein the controller is configured to display, to be adjacent to the meter image, a gauge image in which a plurality of gauges corresponding to the value of the denominator of the gear stage information is arranged along a predetermined direction, the controller being configured to illuminate, among the gauges, the number of gauges corresponding to the value of the numerator of the gear stage information.

3. The display control device according to claim 1, wherein the controller is configured to display the gear stage information in a central part of an arc of the meter image having an arc shape, the controller being configured to display warning information indicating a content of a warning in the central part of the arc of the meter image and shift and display the gear stage information at a position within the arc of the meter image that does not overlap the warning information when a warning condition based on a state of the vehicle is met.

4. The display control device according to claim 1, wherein the controller is configured to display solely the value of the current gear stage as the gear stage information when a shift position of the vehicle is in an M range in which the gear stage is changeable by an operation of the driver.

5. The display control device according to claim 1, wherein the controller is configured to display the gear stage information when a current location of the vehicle is within a travel area that is predetermined.
